(19) United States
(12) Patent Application Publication
(10) Pub. No.: US 2016/0161001 A1
(43) Pub. Date: Jun. 9, 2016

(54) SILICONE GASKET APPARATUS AND METHOD OF MANUFACTURE

(71) Applicants: J Royal US, Inc., Clemmons, NC (US); Kunshan J Royal Precision Products Inc., Kunshan (CN)

(72) Inventors: Darin Jobe, Clemmons, NC (US); Wei Guang Li, Clemmons, NC (US); Doug Jenkins, Clemmons, NC (US); Ping Xiao, Kunshan (CN)

(21) Appl. No.: 14/957,106

(22) Filed: Dec. 2, 2015

Related U.S. Application Data
(60) Provisional application No. 62/087,016, filed on Dec. 3, 2014.

(51) Int. Cl. F16J 15/10; B29C 65/48; B29C 70/68; F16J 15/06

(52) U.S. Cl. CPC F16J 15/102; F16J 15/061; B29C 65/48; B29C 70/68; F16J 15/108; B29K 2083/00

(57) ABSTRACT

A gasket configured to seal an opening between two surfaces including at least one corner and at least one pressure relief notch in the corner. The gasket is formed of silicone and includes several magnets that are molded into the gasket or are inserted into apertures in the gasket in a mating engagement. In one example, the gasket is cut from a sheet of silicone in a flattened state by cutting a center seam, cutting first and second outside seam corner notches, cutting first and second inside seam corner notches, cutting first and second pressure relief notches on the first and second outside seam corner notches, and cutting third and fourth pressure relief notches on the first and second inside seam corner notches. The gasket is then opened up from the flattened state into a picture frame shape, and the first and second outside seam corner notches are glued.

### RELATED APPLICATION DATA

The present application hereby claims priority under 35 U.S.C. §119(e) to U.S. Provisional Patent Application No. 62/087,016 filed Dec. 3, 2014 which is incorporated herein by reference in its entirety.

The present invention is directed towards gaskets and, more particularly, towards gaskets that are used to prevent gases or liquids from leaking between two surfaces.

Gaskets have been used in various industries for generations. A gasket is typically used as a mechanical seal that fills the space between two or more mating surfaces to prevent leaking of gases and/or liquids while under compression. Such gaskets are particularly useful in filling spaces formed by less than perfect mating surfaces. Typically, gaskets are cut from some type of material that exhibits properties that allows the gasket to both seal the media and properly contact the mating surfaces.

One particular type of prior art gasket 10 is one that is used in connection with water heaters that seals the space between the water heater body and its outer door. This prior art gasket 10 is typically formed from a silicate based wool material. Because of the nature of the material, the prior art gasket 10 is die cut or water jet cut, for example, from a sheet to form a rectangular, picture frame-type shape out of the material, as shown in FIG. 1. Pressure sensitive adhesive (PSA) is then applied to the gasket, which is covered with an adhesive protector. When the gasket is ready for installation, the user peels off the adhesive protector to adhere the gasket to the water heater door.

Because prior art gasket 10 described above is cut out of a sheet of silicate based wool material in the picture frame shape, the manufacturing process produces a significant amount of waste, in large part consisting of the middle part 12 of the rectangular gasket that is cut out. These portions 12 are not reusable and, therefore, must be discarded. Additionally, because PSA is applied to the prior art gasket 10, once the user removes the protector and applies the gasket 10 to the desired surface, it is essentially impossible to move the position of the gasket 10 without degrading its adhesive properties. Thus, such prior art gaskets 10 are intended for single use installation; meaning that the user has to be precise in positioning the gasket 10 on the first attempt. This also results in a lot of waste because of natural human error in aligning the gasket 10, which results in the gasket 10 having to be discarded. An additional drawback of the prior art gasket 10 is that if the surface on which the gasket 10 will be applied has not been properly degreased with an industrial degreaser, the PSA does not stick to the surface properly and must be discarded because of the degraded adhesive properties. Finally, the silicate based wool used to form the prior art gaskets 10 forms an effective seal upon installation; however, over time the heat from the water heater burner along with the pressure exerted by the door being tightly bolted to the water heater body causes the gasket 10 to decompose and eventually turn into a burnt paper type material that no longer provides an effective seal. This causes gas leaks that affect the performance of the water heater and increase the hazard risk for such water heaters.

Thus, there is a need in the art for an improved gasket and method of manufacture for the same.

### BRIEF SUMMARY

In view of the foregoing background, example implementations of the present disclosure include a gasket configured to seal an opening between two surfaces including at least one corner, and at least one pressure relief notch in the at least one corner. The gasket is formed of silicone and further includes several apertures for receiving a corresponding number of magnets in a mating engagement such that surfaces of the magnets are substantially flush with the surface of the gasket that faces the surface on which the gasket is applied.

In yet a further implementation of the present disclosure, a method for manufacturing a silicone gasket is provided, including the steps of cutting the gasket from a sheet of silicone in a flattened state. The cutting step further includes cutting a center seam, cutting first and second outside seam corner notches, cutting first and second inside seam corner notches, cutting first and second pressure relief notches on the first and second outside seam corner notches, and cutting third and fourth pressure relief notches on the first and second inside seam corner notches. The method further includes the step of opening the gasket after it has been cut in the flattened state in a picture frame shape and gluing together the first and second outside seam corner notches and the first and second inside seam corner notches. The method additionally includes the step of cutting a number of apertures in the gasket and inserting a corresponding number of magnets in the plurality of apertures such that surfaces of the magnets are substantially flush with a surface of the gasket.

In yet another implementation of the present disclosure, a molded gasket is provided that is formed from a compression molding or injection molding process. In one example, the molded gasket is molded with magnets already in place such that surfaces of the magnets are substantially flush with a surface of the gasket that faces the surface on which the gasket will be applied. In another example, the molded gasket is molded with plurality apertures and a corresponding number of magnets are inserted in the apertures after the molding process such that surfaces of the magnets are substantially flush with a surface of the gasket.

### BRIEF DESCRIPTION OF THE FIGURES

FIG. 1 is a top view of a prior art gasket.

FIG. 2A is a top view of a gasket in a flattened state according to a first implementation of the present disclosure.

FIG. 2B is top view of the gasket of FIG. 2A in a partially open state.

FIG. 3 is a top view of the gasket of FIG. 2A in a fully open picture frame state.

FIG. 4 is a top view of the gasket of FIG. 2A in a fully open picture frame state with pressure relief notches.

FIG. 5 is a close-up view of the gasket of FIG. 4 including inserted magnets.

FIGS. 6A and 6B are perspective views of the gasket of the present disclosure as applied to a water heater door.

FIG. 7A is a front view of a gasket according to a second implementation of the present disclosure.

FIG. 7B is a perspective view of the gasket of FIG. 7A.

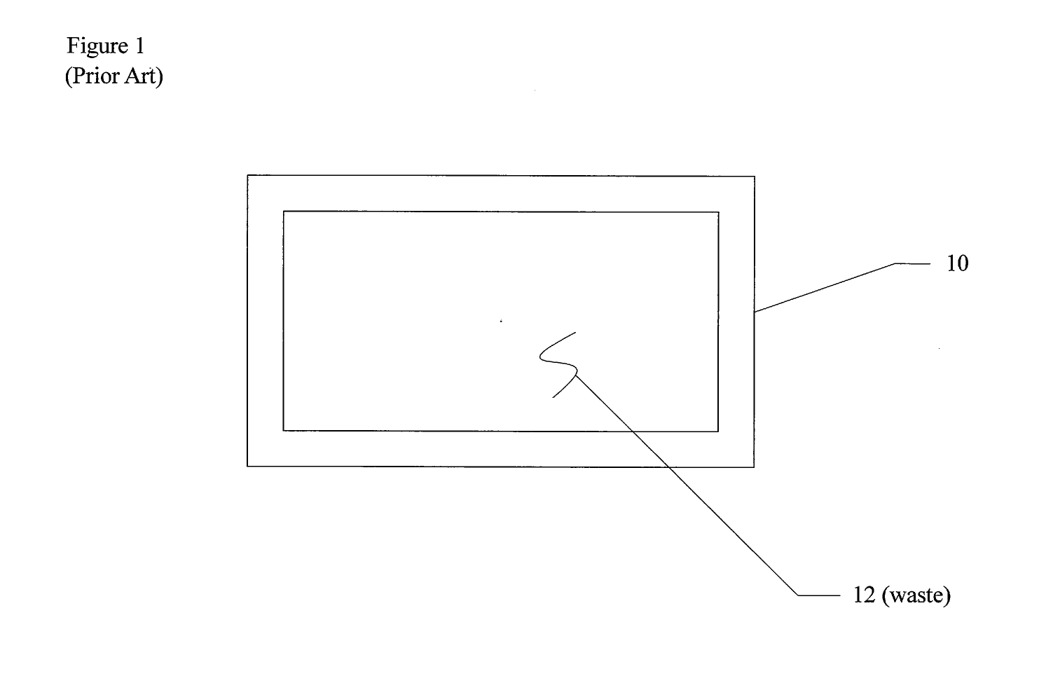

### DETAILED DESCRIPTION OF THE PRESENT INVENTION

The present invention is directed towards a gasket, such as a gasket used to seal water heater doors, that overcomes the deficiencies described above with respect to both manufacture and use. More specifically, the gasket 20 of the present disclosure is formed of silicone, such as silicone rubber or silicone sponge. Silicone is heat resistant and, therefore, doesn't degrade with use as with silicate based wool materials.

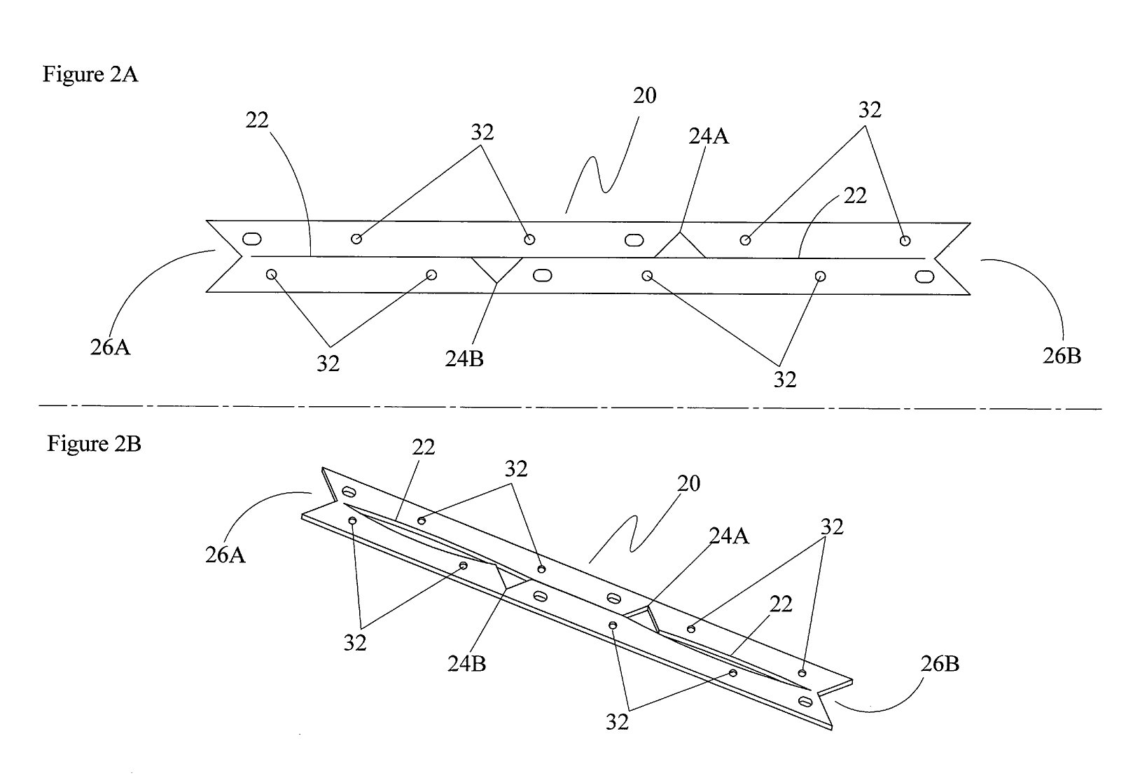

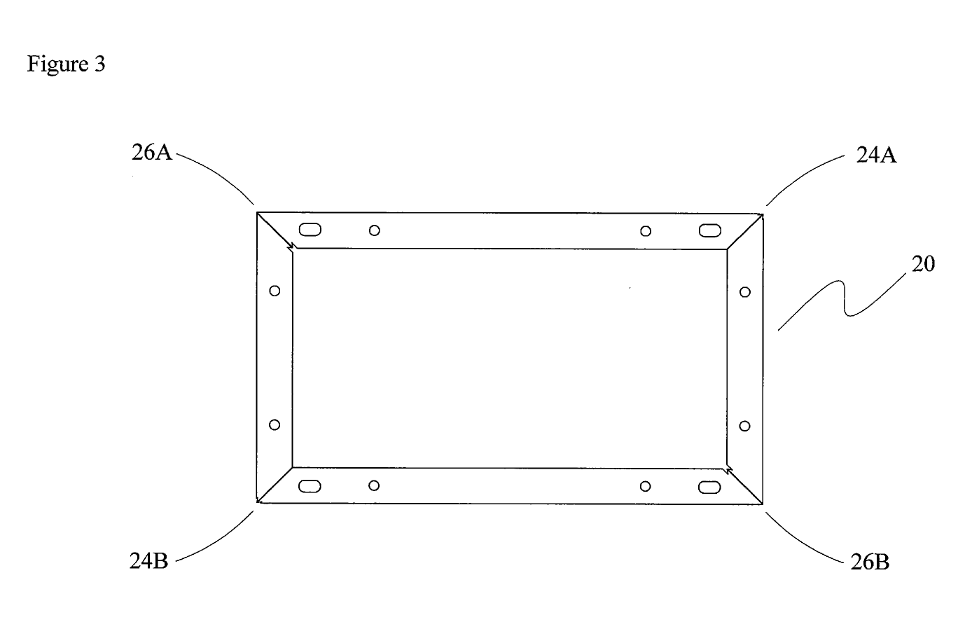

According to a first implementation of the present disclosure, in order to maximize use of the material during the manufacturing process, and correspondingly minimize waste, the silicone gasket 20 is cut (such as die cut or water jet cut) from a silicone sheet in a “flat” configuration, as shown in FIG. 2, which is subsequently opened up into a rectangular, picture frame-type shape, as shown in FIG. 3.

Referring again to FIG. 2, the general outline of the flattened gasket 20 is cut out of the silicone sheet including first corresponding notches 24A, 24B and second corresponding notches 26A, 26B. A seam 22 is also cut through the center of the flattened gasket 20. This process of cutting the gasket 20 in a flattened state eliminates most of the waste of punching a rectangular part out of the material, as described above with respect to the prior art gasket 10. Referring now to FIG. 3, when the gasket 20 is opened up to the picture frame-type shape, the notches 24A, 24B form corners with outside seams and the notches 26A, 26B form opposing corners of the gasket 20 with inside seams.

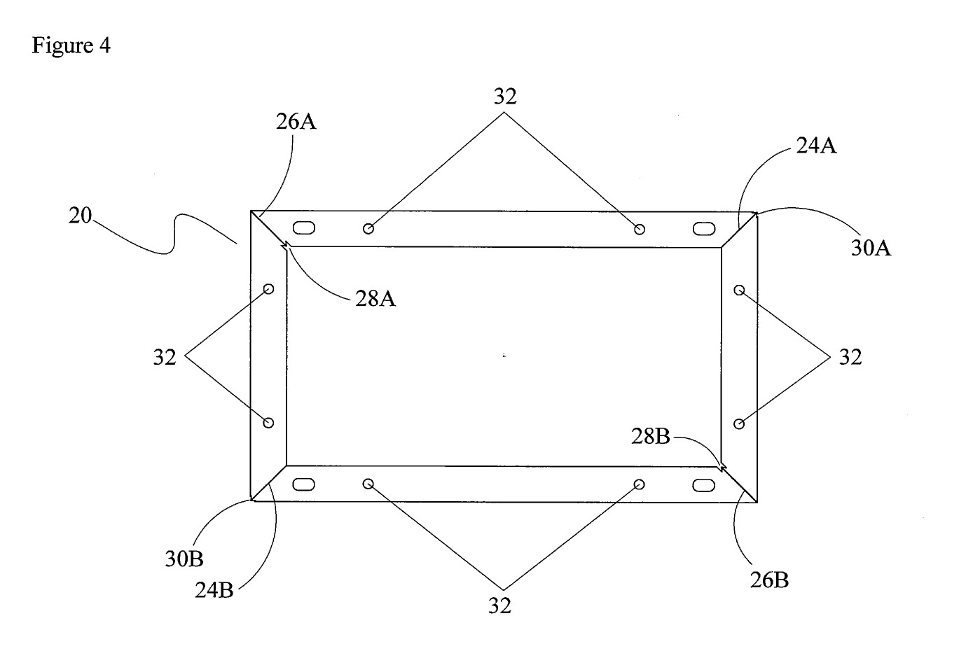

Because silicone is an elastomeric material, it tends to have a lot of “memory” and naturally tries to deform back to its original shape unless it is mechanically held in the desired position. Silicone is also a slippery material that aids the material's tendency to deform. In order to combat this natural tendency of the silicone material, the present invention includes pressure relief notches 28A, 28B, 30A, 30B that are cut into the corners of the gasket 20 as shown in FIG. 4. In the embodiment shown in FIG. 4, pressure relief notches 28A, 28B are cut into the inside corners of the gasket 20 that correspond with corners formed by notches 26A, 26B, respectively. Pressure relief notches 30A, 30B are cut into the outside corners of the gasket 20 that correspond with corners formed by notches 24A, 24B, respectively. By cutting the pressure relief notches 26A, 26B, 30A, 30B in the corners of the gasket 20, the bonds of the elastomeric material are broken so the silicone does not fold back to its original shape. In an example of the present disclosure, in order to further secure the gasket 20 in the rectangular, picture frame shape, silicone sealant glue, such as room temperature vulcanizing sealant, is applied to the outside seams in corners 24A, 24B and the inside seams in corners 26A, 24B to hold the gasket 20 in its intended rectangular position.

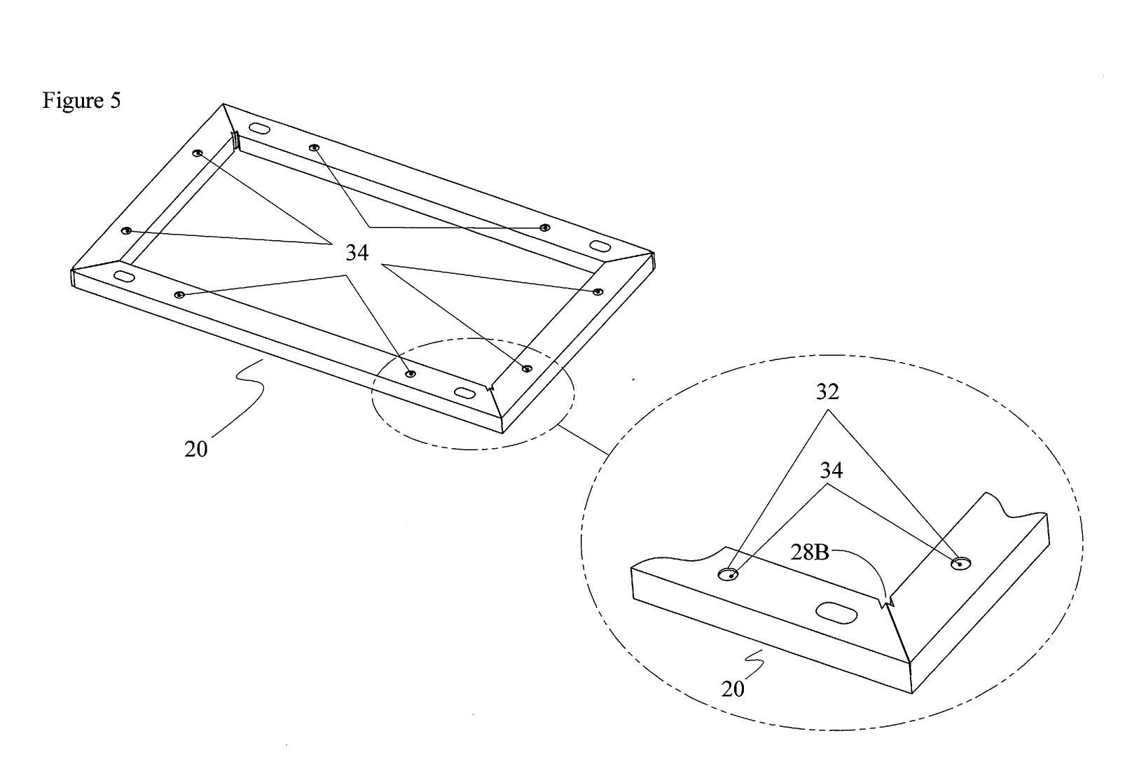

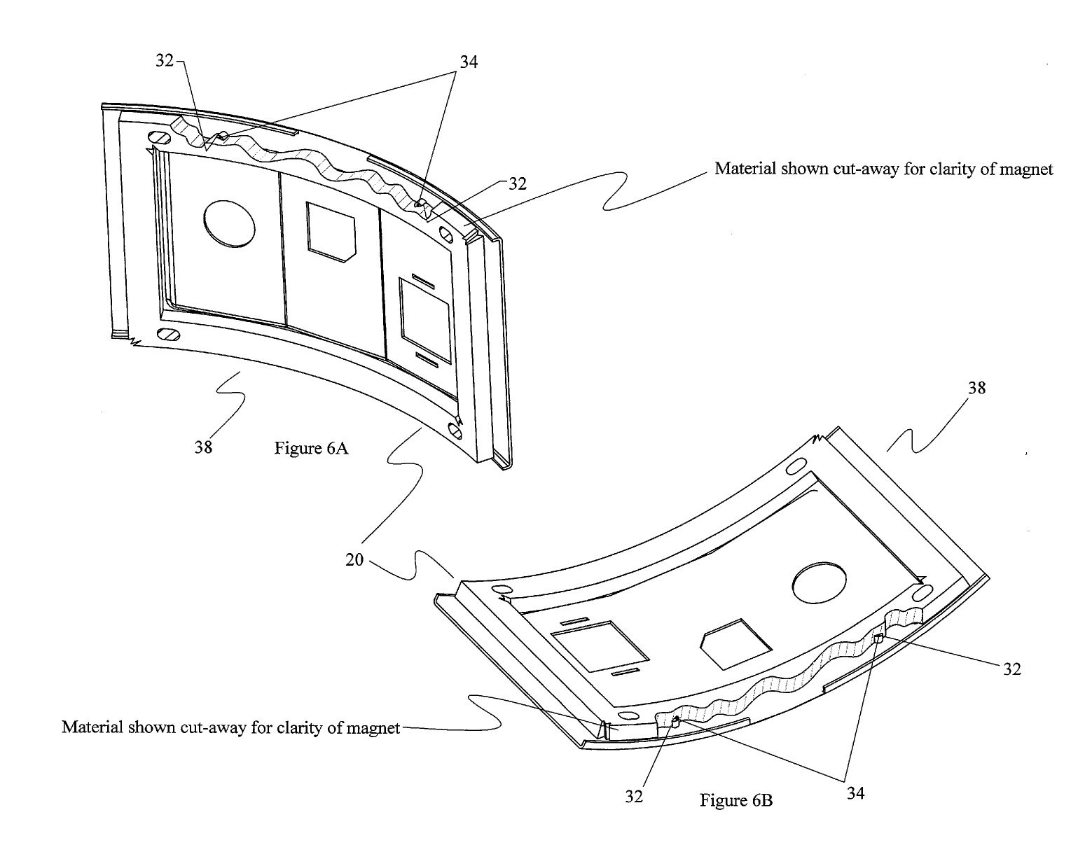

In order to avoid the drawbacks of using PSA as described above with respect to the prior art gasket 10, in an example implementation of the present disclosure, the gasket 20 comprises apertures 32 that are cut out of the perimeter of the gasket 20 on the surface of the gasket 20 that faces the surface on which it will be applied. The apertures 32 stop short of extending all the way though the material so they create pockets for matingly receiving magnets 34 that sit in the apertures 32, as shown in FIG. 5. Once inserted, the surfaces of the magnets 34 are substantially flush with the surface of the gasket 20. The magnets 34 may be glued in this position in the apertures 32. Any number of magnets 34 may be used that is sufficient to allow the gasket 20 to magnetically affix to the metal surface on which it is being applied, such as a metal water heater door. The magnets 34 enable the user to slide the gasket 20 into the proper position or to even remove and reapply the gasket 20 if it is initially misaligned without degrading the sealing properties of the gasket 20. No adhesive or other mechanical means is needed to hold the gasket 20 in place while final assembly and installation of the gasket 20 are performed. Thus, use of the magnets 34 provides the installer with increased flexibility to shift the position of the gasket 20 during installation in case the gasket 20 is not perfectly positioned on the first attempt. The use of magnets 34 instead of PSA also eliminates the annoying smell caused by the burning of PSA in prior art gaskets 10 used for gas water heaters. An example of the gasket 20 of the present disclosure as installed on a metal water heater door 38 is shown in FIGS. 6A and 6B.

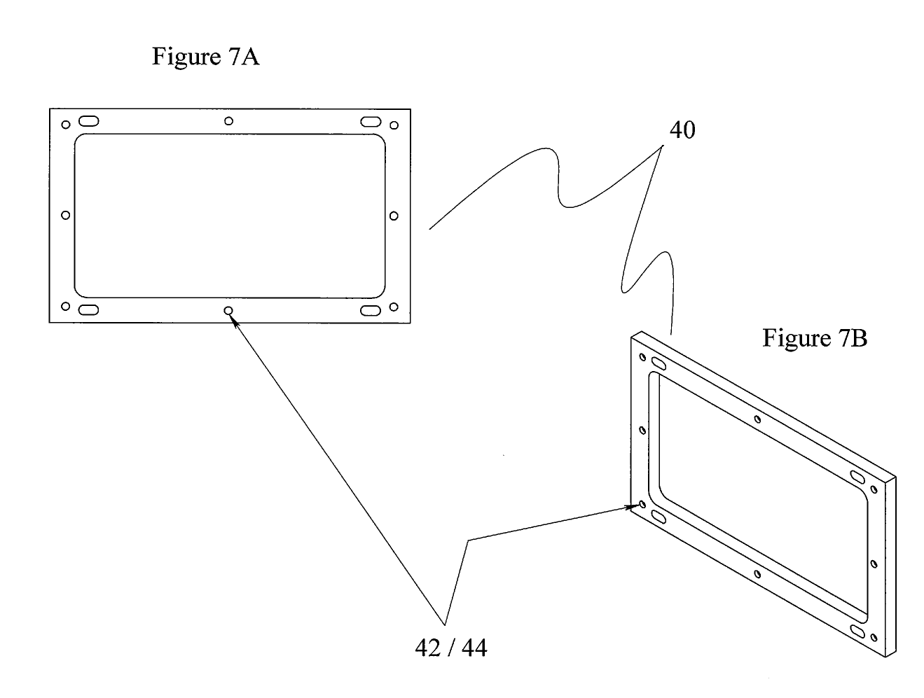

In an alternative implementation of the present disclosure, as shown in FIGS. 7A and 7B, the gasket 40 may be formed from a molding process rather than a die-cut process as described above. Particularly, the gasket 40 may be molded from a raw material (such as silicone) that is pelletized and injected into a steel mold or pre-formed and molded as a compression molded part. In one example, as shown in FIGS. 7A and 7B, the gasket 40 is molded with apertures 42 that stop short of extending all the way through the material to create pockets for matingly receiving magnets 44 (similar to apertures 32 and magnets 34 as shown in FIGS. 2-4) to facilitate placement of the gasket 40. In a second example, the gasket 40 may be molded with the magnets 44 already in place during the molding process.

While certain embodiments of the invention have been described using specific terms, such description is for present illustrative purposes only, and it is to be understood that changes and variations to such embodiments, including but not limited to the substitution of equivalent features or parts, and the reversal of various features thereof, may be practiced by those of ordinary skill in the art without departing from the spirit or scope of the present disclosure. For example, the present invention is not limited to gaskets for use only in connection with water heater doors. Rather, the gasket can be configured for use in many types of applications.

Additionally, the unique method of manufacture of the gasket could be applied to gaskets for use in various industries.

What is claimed is:

1. A gasket configured to seal an opening between two surfaces comprising:
at least one corner; and
at least one pressure relief notch in said at least one corner;
wherein said gasket is formed of silicone.

2. The gasket of claim 1 wherein the gasket further comprises a plurality of apertures and a corresponding plurality of magnets housed within the apertures in a mating engagement such that surfaces of the plurality of magnets are substantially flush with a surface of the gasket.

3. A gasket configured to seal an opening between two surfaces comprising a plurality of magnets housed within the gasket such that surfaces of the magnets are substantially flush with a surface of the gasket.

4. The gasket of claim 3 wherein the gasket is molded using a compression molding or injection molding process.

5. The gasket of claim 3 further comprising a plurality of apertures for housing the corresponding plurality of magnets.

6. A method of manufacturing a silicone gasket comprising the steps of:
cutting the gasket from a sheet of silicone in a flattened state, said cutting step further comprising:
cutting a center seam;
cutting first and second outside seam corner notches;
cutting first and second inside seam corner notches;
cutting first and second pressure relief notches on the first and second outside seam corner notches; and
cutting third and fourth pressure relief notches on the first and second inside seam corner notches.

7. The method of claim 6 further comprising the step of opening the gasket after it has been cut in the flattened state in a picture frame shape and gluing together the first and second outside seam corner notches and the first and second inside seam corner notches.

8. The method of claim 7 further comprising the steps of cutting a plurality of apertures in the gasket and inserting a corresponding plurality of magnets in the plurality of apertures.

9. The method of claim 8 wherein respective surfaces of the plurality of magnets are substantially flush with a surface of the gasket.

10. A method of manufacturing a silicone gasket comprising the step of molding the gasket with at least two magnets such that respective surfaces of the magnets are substantially flush with a surface of the gasket.

11. The method of claim 10 wherein the molding step comprises the step of injection molding or compression molding with pellets of silicone.

12. A method of manufacturing a molded gasket to seal an opening between two surfaces comprising the steps of:
molding the gasket with at least two apertures; and
securing a corresponding plurality of magnets within the apertures in a mating engagement such that respective surfaces of the plurality of magnets are substantially flush with a surface of the gasket.
